(19) United States
(12) Patent Application Publication
(10) Pub. No.: US 2019/0251214 A1
(43) Pub. Date: Aug. 15, 2019

(54) DESIGN METHOD FOR ASSISTIVE DEVICE AND ELECTONIC SYSTEM FOR ASSISTIVE DEVICE DESIGN

(71) Applicant: Industrial Technology Research Institute, Hsinchu (TW)

(72) Inventors: Wei Li, Hsinchu City (TW); Yu-Lin Chao, Hsinchu City (TW); Chih-Ming Shen, New Taipei City (TW); Ming-Chi Tai, Hsinchu City (TW); Miao-Zhen Hong, Changhua County (TW)

(73) Assignee: Industrial Technology Research Institute, Hsinchu (TW)

(21) Appl. No.: 16/022,705

(22) Filed: Jun. 29, 2018

(30) Foreign Application Priority Data
Feb. 9, 2018 (TW) 107104784

(51) Int. Cl. G06F 17/50; B29C 64/386; B33Y 50/02; G06T 17/00; B33Y 10/00

(52) U.S. Cl. CPC G06F 17/5009; B29C 64/386; G06T 2207/10028; G06T 17/00; B33Y 10/00; B33Y 50/02

(57) ABSTRACT

A design method of an assistive device and an electronic system of assistive device design are provided. The design method of the assistive device are adapted for an electronic devices including a processor. The design method includes: obtaining a point cloud data of a limb part; determining a plurality of reference cross sections according to the point cloud data, wherein each of the reference cross sections is determined corresponding to bone protrusion feature points of the point cloud data, wherein the bone protrusion feature points are corresponding to the bony prominences of the limb parts respectively; establishing an initial digital model of the assistive device according to the reference cross sections; and performing a structural simulation analysis according to the initial digital model and design limitations to obtain a product digital model of the assistive device.

### CROSS-REFERENCE TO RELATED APPLICATION

This application claims the priority benefit of Taiwan application serial no. 107104784, filed on Feb. 9, 2018. The entirety of the above-mentioned patent application is hereby incorporated by reference herein and made a part of this specification.

### TECHNICAL FIELD

The technical field relates to assistive device and electronic system for assistive device design. In another aspect, the invention relates to assistive device for limb parts and electronic system for assistive device design for limb parts.

### BACKGROUND

Assistive devices are often used when people get injury and with disabilities, such as plaster, crutch, protective clothing, prosthetics, and so on. Distinguished by abilities, the assistive device can be divided to the species as follows. The movement assistive devices such as wheelchair, corrective shoes, walking frame, and crutch. The physical function assistive devices such as prosthetics for arm or legs and pencil grip. The living assistive devices such as safety alarm and stair climber. The treatment assistive devices such as plaster, backrest, waist guard, knee guard, neck guard, and cushion. The assistive devices commonly used by consumers are associated with body movement and physical function such as protective clothing, walking frame, prosthetics, and plaster.

In general, assistive devices for fixing limbs are often used by experienced doctors or health care providers by plaster or molds, but assistive devices made by plaster often provides awful user experience. For example, due to the plaster is hardened after cool down, the skin of user is very uncomfortable while contacting the hardened plaster. In another aspect, the assistive devices made by plaster are formed in high temperature, so it is hard to change the material or structure to fulfill customized requirements. Although the assistive devices can be produced in different sizes, but they also can't fit every user's limb perfectly and provide comfort to the users.

### SUMMARY

A design method for assistive devices and an electronic system for assistive devices design are provided.

In an exemplary embodiment, a design method for an assistive device, and the design method is apply to an electronic device comprising a processor, the design method comprising: obtaining point cloud data of a limb part; generating a plurality of reference cross sections according to the point cloud data, wherein each of the reference cross sections are determined by a plurality of bone protrusion feature points, wherein the bone protrusion points are respectively corresponding to a plurality of bony prominences of the limb part; establishing an initial digital model of the assistive device according to the reference cross sections; and performing a structural simulation analysis according to the initial digital model and a plurality of design limitations to obtain a product digital model of the assistive device.

In another exemplary embodiment, An electronic system for designing an assistive device comprising: a 3D scanner, for scanning a limb part for generating a point cloud data; and an electronic device comprising a processor, the electronic device is coupled to the 3D scanner; wherein the processor receives the point cloud data of the limb part from the 3D scanner; wherein the processor determining a plurality of reference cross section according to the point cloud data, wherein each of the reference cross section is determined by a plurality bone protrusion feature points in the point cloud data, wherein the bone protrusion feature points are respectively corresponding to a plurality of bony prominences of the limb part; wherein the processor establish an initial digital model of the assistive device according to the reference cross sections, and performs a structural simulation analysis according to the initial digital model and a plurality of design limitations to establish a product digital model of the assistive device.

Another exemplary embodiment of a method for designing an assistive device for an electronic device comprising a processor and a display device, the method comprising: obtaining a point cloud data of a limb part by the processor, and display the point cloud data by the display device; determining a plurality of reference cross sections by a user interface executed by the processor according to the point cloud data, wherein each of the reference cross sections are determined by a plurality of bone protrusion feature points in the point cloud data, and the bone protrusion feature points are respectively corresponding to a plurality of bony prominences of the limb part; establishing an initial digital model of the assistive device by the processor according to the reference cross sections; and performing a structural simulation analysis by the processor according to the initial digital model and a plurality of design limitations to establish a product digital model of the assistive device.

Methods disclosed above may be practiced by the devices or systems disclosed above which are hardware or firmware capable of performing particular functions and may take the form of program code embodied in a memory and/or embodied in a computer-readable storage medium/computer program product, combined with specific hardware. When the program code is loaded into and executed by an electronic device, a controller, a computer processor or a machine, the electronic device, the processor, the computer or the machine becomes an apparatus or system for practicing the disclosed method.

### BRIEF DESCRIPTION OF THE DRAWINGS

The application will become more fully understood by referring to the following detailed description with reference to the accompanying drawings, wherein:

FIG. 1 is a block diagram illustrating an electronic system for designing assistive devices according to an embodiment of the application;

FIG. 2 is a schematic diagram of a design method of assistive devices according to an embodiment of the application;

FIG. 3 is an illustration of point cloud data and cross sections of a hand part according to an embodiment of the application;

FIG. 4a and FIG. 4b is an illustration of point cloud data and cross sections of a right hand part according to an embodiment of the application;

FIG. 5a and FIG. 5b is an illustration of point cloud data and a cross section of a right hand part according to an embodiment of the application;

FIG. 6 is an illustration of point cloud data and a cross section of a right hand part according to an embodiment of the application;

FIG. 7 is an illustration of point cloud data and an assistive device of a right hand part according to an embodiment of the application.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that the embodiments may be realized in software, hardware, firmware, or any combination thereof.

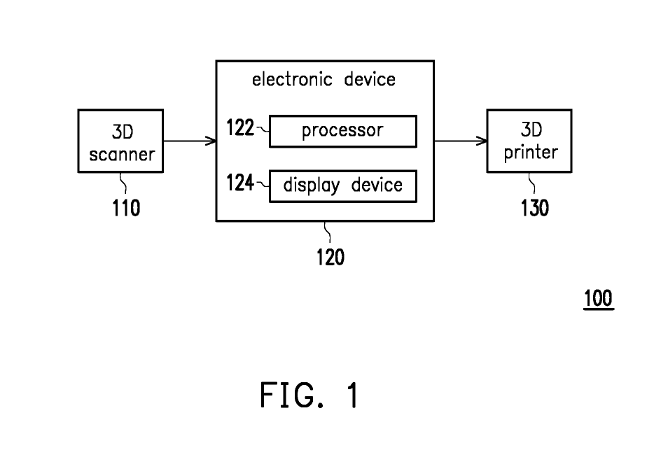

FIG. 1 is a block diagram illustrating an electronic system for designing assistive devices according to an embodiment of the application. As shown in FIG. 1, an electronic system 100 comprises the 3D scanner 110 and an electronic device 120. The electronic device 120 comprises a processor 122 and a display device 124. The 3D scanner 110 scans a limb part of a user to generate point cloud data of the limb part. For example, the user can put his hand part or foot part into a scanning region of the 3D scanner 110 to obtain the point cloud data through 3D scanning technique.

The processor 122, for example, is a central processing unit (CPU), a microprocessor, an embedded control chip, a digital signal processor (DSP), an application specific integrated circuits (ASIC), or so on. The display device 124 can display the point cloud data received by the electronic device 120 and a user interface executed by the processor 122. In the embodiment, the user interface can be displayed as window screens, each of the window screens is able to display different information such as point cloud data in different aspect of views, a digital model of the assistive device, and so on. The processor 122 can quickly determine bone protrusion feature points among the point cloud data through the user interface by the design method in the embodiment of the application, and the processor 122 establishes an initial digital model of the assistive device according to the bone protrusion feature points. Then, the processor 122 performs a structural simulation according to the initial digital model to establish a product digital model of the assistive device. Therefore, the product digital model of the assistive device can avoid extrusion on the bony prominences of the limb part, thus the assistive device can also provide comfort when supporting the limb part.

The 3D printer 130 is coupled to the electronic device 122, and the 3D printer 130 produces the assistive device according to the product digital model of the assistive device. Because of the product digital model is established after the structural simulation, the product digital model may has different structures as compare to the structure of conventional assistive devices. Therefore, the assistive device of the embodiment of the application is recommended to produce through 3D printing technique. Moreover, 3D printing technique is capable to transform the product digital model to a final product in a short time. As a result, the production period of a customized assistive device can be shortened.

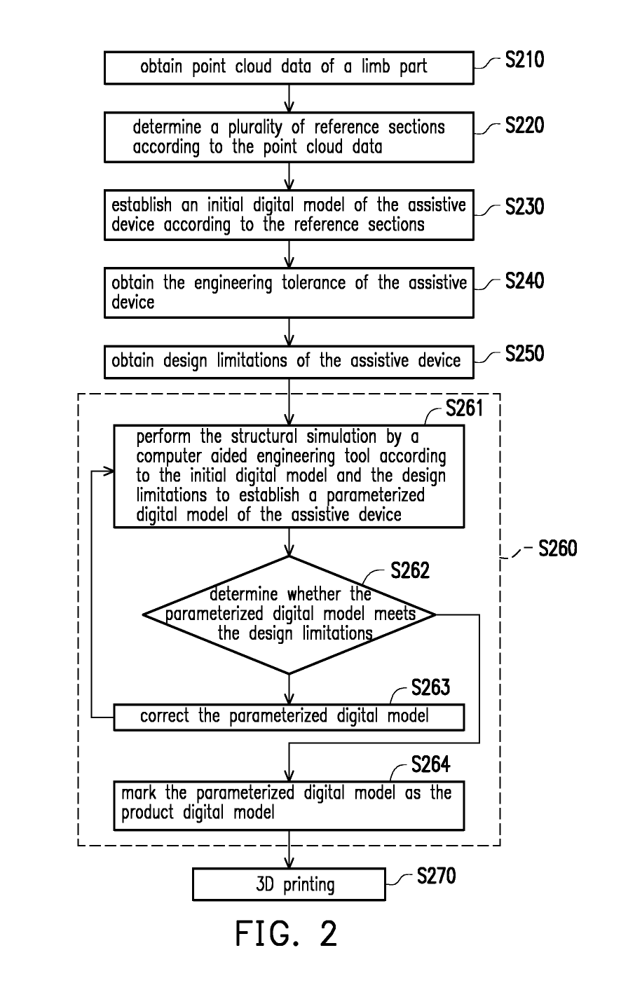

FIG. 2 is a schematic diagram of a design method of assistive devices according to an embodiment of the application. Please refer to FIG. 1 and FIG. 2, the design method of assistive devices of the embodiment is adapted for an electronic device 120 comprising a processor 122. In step S210, the processor 122 obtains point cloud data of a limb part, the point cloud data is generated by a 3D scanner 110 through scanning the limb part of a user. In the embodiment, the limb part is illustrated as a hand part.

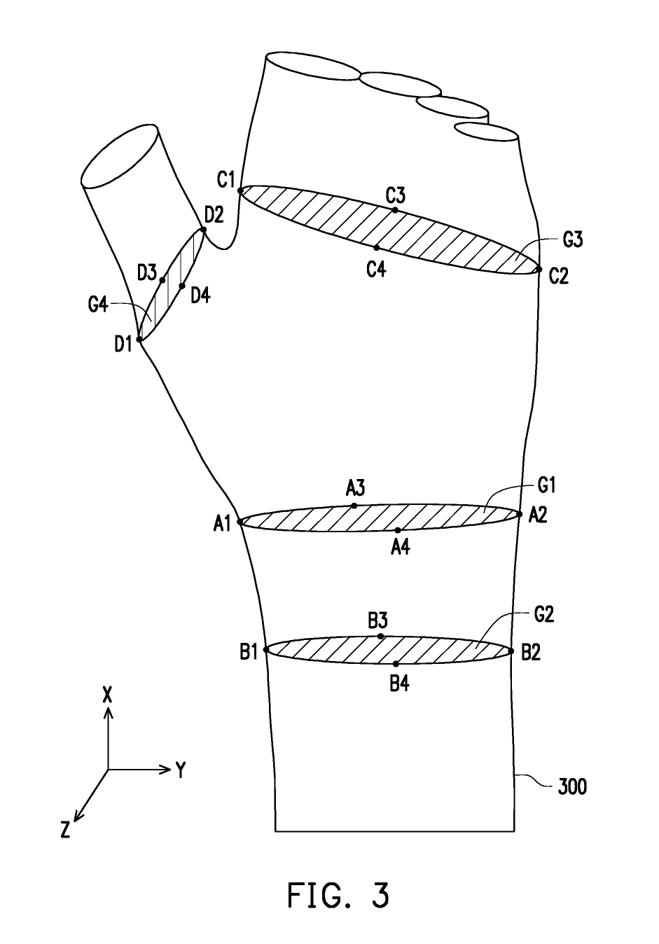

In step S220, the processor 122 determines a plurality of reference sections according to the point cloud data. Each of the reference sections is determined by the bone protrusion feature points in the point cloud data respectively, and each of the bone protrusion feature points corresponding to a plurality of bony prominences of the limb part. For example, bony prominences is located at the root of fingers, the wrist back of a hand, and the ankle of a foot. FIG. 3 is an illustration of point cloud data 300 and cross sections G1 to G4 of a hand part according to an embodiment of the application. Refer to FIG. 3, the bone protrusion feature points are determined among the point cloud data 300 to produce a customized assistive device of a hand, and the reference sections G1 to G4 are determined according to the bone protrusion feature points. Direction indications of x axis, y axis, and z axis are also shown in FIG. 3 to determine the direction of the point cloud data 300. If the bony prominences are determined as the reference points of the assistive device, the user may feel more comfortable when wearing the assistive device by avoiding extrusion on the bones from the assistive device. In the following paragraph, the embodiment will describe how the reference sections G1 to G4 are formed by the bone protrusion feature points.

Refer to FIG. 2, in step S230, the processor 122 establishes an initial digital model of the assistive device according to the reference sections G1 to G4. As a result of the assistive device is meant to support the limb, edges of the assistive device may be shown as curves instead of lines. In other words, the initial digital model is a reference model shown as curves. In step S240, the processor 122 may obtain the engineering tolerance of the assistive device, such as a 1 mm engineering tolerance in the embodiment. The engineering tolerance may be input by external devices such as user input, set by an experienced assistive device designer, or a pre-determined parameter in the electronic device 120. In step S250, the processor 122 may obtain design limitations of the assistive device, such as the structure strength, weight, material, or a combination thereof. In other words, the design limitations may called as design rules, those parameters associated with the assistive device may be input according to the user requirement in the embodiment. Then, a structural simulation is performed by the electronic device as the following.

In step S260, the processor 122 performs the structural simulation according to the initial digital model and the design limitations to establish a product digital model of the assistive device. In step S261, the processor 122 performs the structural simulation by a computer aided engineering tool according to the initial digital model and the design limitations input ay step S240 and S250, to establish a parameterized digital model of the assistive device. The parameterized digital model may also called as a model of finite element method. The structural simulation is performed by structure algorithm to produce a digital model of the assistive device with enough supporting strength. In the embodiment, the finite element method is established by mesh split.

In step S262, the processor 122 determines whether the parameterized digital model meets the design limitations in step S250. When the parameterized digital model does not meet the design limitations, the process is proceed from step S262 to S263 and the processor 122 corrects the parameterized digital model. The correction mentioned above may be performed by the processor 122 automatically, by the user input manually, or by a doctor or an experienced assistive device designer modifies part of the parameters or materials of the assistive device. After the correction in step S263, the processor 122 may proceed step S261 from S263 to perform the structural simulation by the computer aided engineering tool to establish a modified parameterized digital model of the assistive device.

When the parameterized digital model or modified parameterized digital model established in step S261 meets the design limitations, the process is proceed from step S262 to S264. The processor 122 marks the parameterized digital model or the modified parameterized digital model as the product digital model when he parameterized digital model or the modified parameterized digital model meets the design limitations. Therefore, a 3D limb digital model of a customized assistive device may be produced in a short time through step S210 to S260 according to the bony prominences of the limb. In step S270, the 3D printer 130 may produce the assistive device according to the product digital model of the assistive device, and performs surface treatment to the assistive device such as polishing. As the result, the assistive device may be produced quickly and automatically. The digital models in the embodiment are established by structural algorithm according to the point cloud data of the limb part. Therefore, the assistive device can avoid extrusion on the bony prominences of the limb part, thus the assistive device can also provide comfort when supporting the limb part.

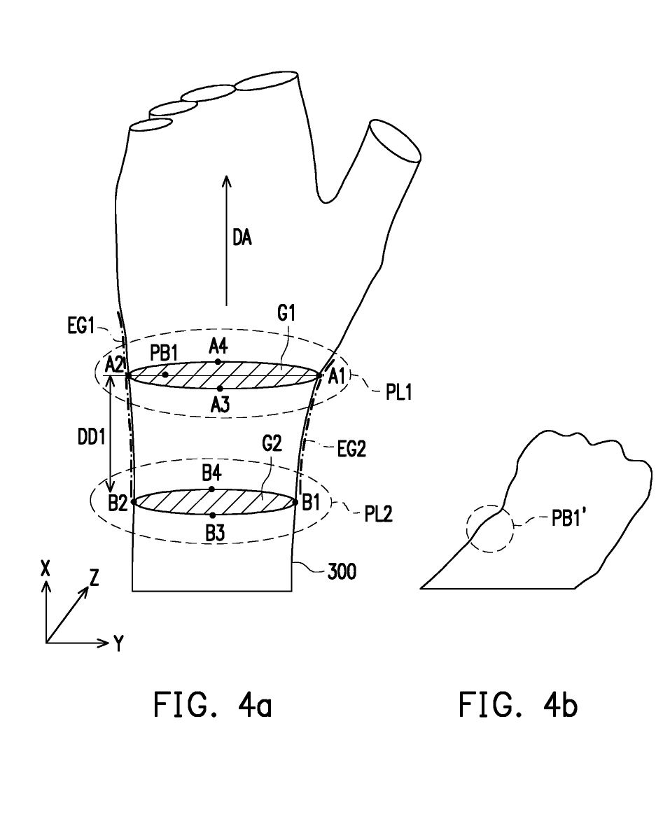

The following paragraph will describe how to determine reference sections G1 to G4 and protector reference points A1 to A4, B1 to B4, C1 to C4, and D1 to D4 of the assistive device according to the bone protrusion feature points. The protector reference points are used to determine the corresponding reference sections of the initial digital model of the assistive device. In the embodiment, each of the reference sections has four corresponding protector reference points respectively. FIG. 4a and FIG. 4b is an illustration of point cloud data 300 and cross sections G1 and G2 of a right hand part according to an embodiment of the application. FIG. 4a is an illustration of the point cloud data 300, and FIG. 4b illustrates is an illustration of the right hand part. The reference section G1 is determined by the following steps. First, a bone protrusion feature point PB1 corresponding to a first bony prominence PB1′ at the wrist back of the right hand is determined among the point cloud data 300. Please also refer to FIG. 4b, it illustrates the location of the first bony prominence PB1′ of the right hand part. Then, the first protector reference points A1, A2, A3, A4 is determined at the intersection (such as the first reference section G1) of the point cloud data 300 and a first surface PL1 which includes the first bone protrusion feature point PB1. The first surface PL1 is corresponding to the cross section of the hand part. The first protector reference points A1 to A4 can be used to form the first reference section G1. In the embodiment, a point at the most left A1, a point at the most right A2, a point at the uppermost on the back of the hand A3, and the lowermost at the wrist of the hand A4 are determined as the first protector reference points. The first surface PL1 is vertical to an arm direction DA. In the embodiment, the arm direction DA (or called an axis direction of the hand part) may be determined by two edge lines of the arm such as edge lines EG1 and EG2. Also, the arm direction DA may be determined by a middle line of the edge lines EG1 and EG2.

The reference section G2 is determined as the following process. In the embodiment, a second surface PL2 is formed by moving the first surface PL1 along a reversed direction of the arm direction DA for a first offset distance DD1 according to a doctor indication or rule of thumb. Then, the second protector reference points B1 to B4 are determined at the intersection (such as a second reference section G2) of the point cloud data 300 and the second surface PL2. The second protector reference points B1 to B4 are used to form the second reference section G2. The second reference section G2 is determined according to a protection area of the assistive device includes the wrist or arm part of the limb or not. If the assistive device also provides protection to the arm part, the first offset distance DD1 is larger. If the assistive device only provides protection to the wrist part, the first offset distance DD1 is smaller.

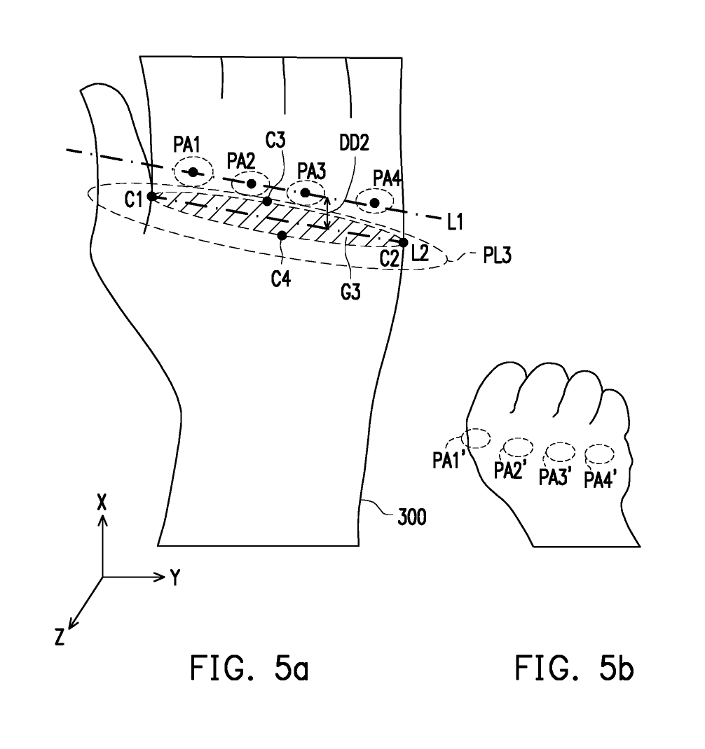

FIG. 5a and FIG. 5b is an illustration of point cloud data 300 and cross section G3 of a right hand part according to an embodiment of the application. FIG. 5a is an illustration of the point cloud data 300, and FIG. 5b is an illustration of the right hand part. First, a plurality third bone protrusion feature points PA1 to PA4 are determined among the point cloud data 300. The third bone protrusion feature points are respectively corresponding to bony prominences at the joints at the forefinger PA1′, the middle finger PA2′, the ring finger PA3′, and the little finger PA4′. The locations of the bony prominences PA1′. PA2′, PA3′, and PA4′ are illustrated in FIG. 5b. The processor 122 generates a first section line L1 according to the third bone protrusion feature points PA1 to PA4, which makes the sum of a distance between the first section line L1 and each of the third bone protrusion feature points PA to PA4 is the smallest. Then, a second section line L2 is generated by moving the first section line L1 for a second offset distance DD2 according to a doctor indication or rule of thumb. After that, a second surface PL3 is formed which includes the second section line L2. The third surface PL3 is corresponding to the cross section of the hand part. Moreover, the third protector reference points C1 to C4 are determined at the intersection (a third reference section) of the point cloud data 300 and the third surface PL3. The third protector reference points C1 to C4 form the third reference section. The second offset distance DD2 may be adjusted by a doctor or an experienced designer of assistive device to improve comfort of the user or strengthen a fixability at a particular location of the assistive device.

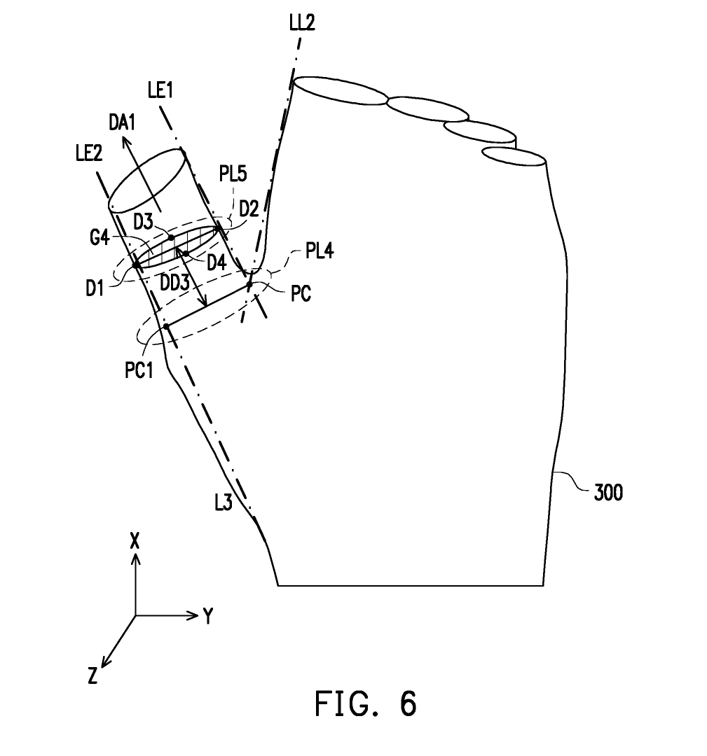

FIG. 6 is an illustration of point cloud data 300 and cross section G4 of a right hand part according to an embodiment of the application. First, a first section line LE1 and a second section line LL2 are extended to obtain a point of intersection PC. The first section line LE1 is corresponding to a contour of a side of the thumb neighboring to the forefinger. The second section line LL2 is corresponding to a contour of a side of the forefinger neighboring to the thumb. The point of intersection PC is projected to a third section line LE2 to form a first point PC1. The third section line LE2 is corresponding to a contour of the thumb not neighboring to the forefinger, and the third section line LE2 determines a second bone protrusion feature point at the location where the third section line LE2 passes a bony prominence of the thumb. Then, a fourth surface PL4 is formed which includes the point of intersection PC and the first point PC1. The fifth surface PL5 are formed by moving the fourth surface PL4 along a finger direction of the thumb DAI for an offset distance DD3. Finally, the fourth protector reference points D1 to D4 are determined at the intersection (a fourth reference section G4) of the point cloud data 300 and the fifth surface PL5. The fourth protector reference points D1 to D4 form the fourth reference section G4.

As the embodiment described above, the initial digital model of the assistive device can be established in step S230 according to the first protector reference points A1 to A4, the second protector reference points B1 to B4, the third protector reference points C1 to C4, and the fourth protector reference points D1 to D4. Then, the step S240 to S270 are performed.

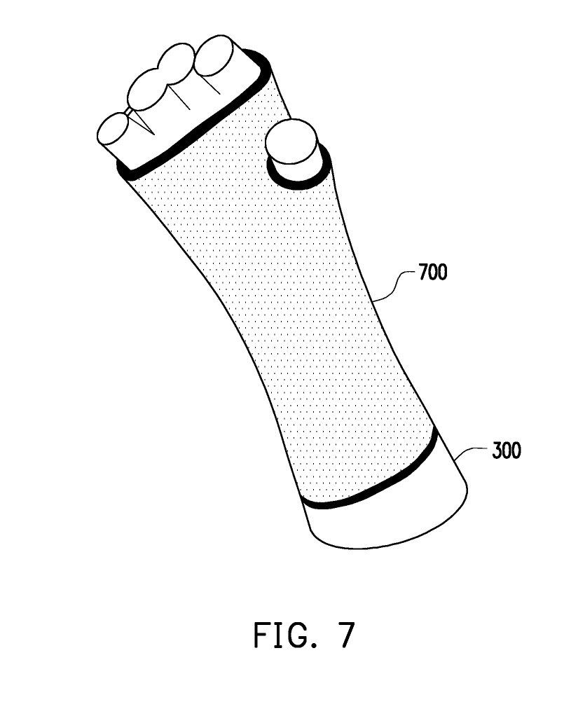

FIG. 7 is an illustration of point cloud data 300 and an assistive device 700 of a right hand part according to an embodiment of the application. The assistive device 700 designed and produced by the embodiment of the application can avoid or strengthen the location between bony prominences and the assistive device. As a result, the bony prominences are hardly to contact or rub with the assistive device and then provides comfort to the user.

While the application has been described by way of example and in terms of exemplary embodiment, it is to be understood that the application is not limited thereto. Those who are skilled in this technology can still make various alterations and modifications without departing from the scope and spirit of this application. For example, the systems and methods described in the embodiments of the present APPLICATION may be implemented in physical embodiments of hardware, software, or a combination of hardware and software. Therefore, the scope of the present application shall be defined and protected by the following claims and their equivalents.

What is claimed is:

1. A design method for an assistive device, and the design method is apply to an electronic device comprising a processor, the design method comprising:
obtaining point cloud data of a limb part;
generating a plurality of reference cross sections according to the point cloud data, wherein each of the reference cross sections are determined by a plurality of bone protrusion feature points, wherein the bone protrusion feature points are respectively corresponding to a plurality of bony prominences of the limb part;
establishing an initial digital model of the assistive device according to the reference cross sections; and
performing a structural simulation analysis according to the initial digital model and a plurality of design limitations to obtain a product digital model of the assistive device.

2. The design method for the assistive device as claimed in claim 1, further comprising obtaining the point cloud data through scanning the limb part by a 3D scanner.

3. The design method for the assistive device as claimed in claim 1, further comprising producing the assistive device through a 3D printer according to the product digital model.

4. The design method for the assistive device as claimed in claim 1, wherein the design limitations comprises at least one of an engineering tolerance, a structure strength, a weight, a material parameter, or a combination of thereof.

5. The design method for the assistive device as claimed in claim 1, wherein performing the structural simulation analysis according to the initial digital model and the design limitations to obtain the product digital model comprising:
performing the structural simulation analysis according to the initial digital model and the design limitations to establish a parameterized digital model of the assistive device by a computer aided engineering tool;
determining whether the parameterized digital model meets the design limitations;
correcting the parameterized digital model when the parameterized digital model does not meet the design limitations, and establish a modified parameterized digital model of the assistive device by the computer aided engineering tool; and
marking the parameterized digital model or the modified parameterized digital model as the product digital model when the parameterized digital model or the modified parameterized digital model meets the design limitations.

6. The design method for the assistive device as claimed in claim 1, wherein the limb part is a hand, and wherein generating the reference cross sections according to the point cloud data comprising:
determining a first bone protrusion feature point among the point cloud data corresponding to a bony prominence at a wrist back of the hand; and
forming a first surface at the first bone protrusion feature point, and determining a plurality of first protector reference points at an intersection of the point cloud data and the first surface, wherein the first surface is corresponding to the a cross section of the hand, and the first protector reference points forms a first reference cross section.

7. The design method for the assistive device as claimed in claim 6, wherein generating the reference cross sections according to the point cloud data further comprising:
forming a second surface by moving the first surface along an arm direction of the hand for a first offset distance; and
determining a plurality of second protector reference points at an intersection of the second surface and the point cloud data, wherein the second protector reference points forms a second reference cross section.

8. The design method for the assistive device as claimed in claim 7, wherein generating the reference cross sections according to the point cloud data further comprising:
determining a plurality of third bone protrusion feature points among the point cloud data, wherein the third bone protrusion feature points are respectively corresponding to bony prominences at a forefinger, a middle finger, a ring finger, and a little finger;
forming a first section line according to the third bone protrusion feature points, wherein a sum of distance between the first section line to each of the third bone protrusion feature points is the smallest;
forming a second section line by moving the first section line for a second offset distance; and
forming a third surface at the second section line, wherein the third surface is corresponding to a cross section of the hand, and determining a plurality of third protector reference points at an intersection of the third surface and the point cloud data, wherein the third protector reference points forms a third reference cross section.

9. The design method for the assistive device as claimed in claim 8, wherein generating the reference cross sections according to the point cloud data further comprising:
generating a point of intersection by extending the first section line and a second section line, wherein the first section line corresponds to a contour of a side of a thumb neighboring to the forefinger of the hand, wherein the second section line corresponds to a contour of a side of the forefinger neighboring to the thumb;
forming a first point by projecting the point of intersection to a third section line, wherein the third section line corresponds to a contour of a side of the thumb not neighboring to the forefinger, and a second bone protrusion feature point is formed at an intersection of the third section line and a bony prominence of the thumb;
forming a fourth surface comprises the point of intersection and the first point;
forming a fifth surface by moving the fourth surface along a finger direction; and
determining a plurality of fourth protector reference points at an intersection of the fifth surface and the point cloud data, wherein the fourth protector reference points forms a fourth reference cross section.

10. The design method for the assistive device as claimed in claim 9, wherein the initial digital model is generated according to the first protector reference points, the second protector reference points, the third protector reference points, and the fourth protector reference points.

11. An electronic system for designing an assistive device comprising:
a 3D scanner, for scanning a limb part for generating a point cloud data; and
an electronic device comprising a processor, the electronic device is coupled to the 3D scanner;
wherein the processor receives the point cloud data of the limb part from the 3D scanner;
wherein the processor determining a plurality of reference cross section according to the point cloud data, wherein each of the reference cross section is determined by a plurality bone protrusion feature points in the point cloud data, wherein the bone protrusion feature points are respectively corresponding to a plurality of bony prominences of the limb part; and
wherein the processor establish an initial digital model of the assistive device according to the reference cross sections, and performs a structural simulation analysis according to the initial digital model and a plurality of design limitations to establish a product digital model of the assistive device.

12. The electronic system for designing an assistive device claimed in claim further comprising a 3D printer coupled to the electronic device, wherein the 3D printer produces the assistive device according to the product digital model.

13. The electronic system for designing an assistive device claimed in claim 11, wherein the design limitations comprises at least one of an engineering tolerance, a structure strength, a weight, a material parameter, or a combination of thereof.

14. The electronic system for designing an assistive device claimed in claim 11, wherein the processor performs the structural simulation analysis according to the initial digital model and the design limitations by a computer aided engineering tool to establish a parameterized digital model of the assistive device, and the processor determine whether the parameterized digital model meets the design limitations;
wherein the processor corrects the parameterized digital model by the computer aided engineering tool according to the design limitations and establish a modified parameterized digital model of the assistive device when the parameterized digital model does not meet the design limitations; and
wherein the processor marks the parameterized digital model or the modified parameterized digital model as the product digital model when the parameterized digital model or the modified parameterized digital model meets the design limitations.

15. A method for designing an assistive device for an electronic device comprising a processor and a display device, the method comprising:
obtaining a point cloud data of a limb part by the processor, and display the point cloud data by the display device;
determining a plurality of reference cross sections by a user interface executed by the processor according to the point cloud data, wherein each of the reference cross sections are determined by a plurality of bone protrusion feature points in the point cloud data, and the bone protrusion feature points are respectively corresponding to a plurality of bony prominences of the limb part;
establishing an initial digital model of the assistive device by the processor according to the reference cross sections; and
performing a structural simulation analysis by the processor according to the initial digital model and a plurality of design limitations to establish a product digital model of the assistive device.
